(19) United States
(12) Patent Application Publication
(10) Pub. No.: US 2011/0089101 A1
(43) Pub. Date: Apr. 21, 2011

(54) FUEL FILTER

(75) Inventor: Giorgio Girondi, Mantova (IT)

(73) Assignee: UFI INNOVATION CENTER S.R.L., Ala (Trento) (IT)

(21) Appl. No.: 12/999,023

(22) PCT Filed: Sep. 24, 2008
(86) PCT No.: PCT/EP08/62778

§ 371 Date: Dec. 14, 2010

(30) Foreign Application Priority Data
Jun. 23, 2008 (IT) RE2008A000054

(51) Int. Cl. B01D 35/30

(52) U.S. Cl. 210/444

(57) ABSTRACT

A fuel filter, in particular for Diesel engine fuel, comprising a closed casing, the internal volume of which comprises at least a first chamber, connected to an inlet for the fuel to be filtered, and a second chamber connected to an outlet for the filtered fuel. A filter screen and a hydrophobic mesh are positioned between the first chamber and the second chamber, and the filter screen is removably fitted to the filter, independently of the hydrophobic mesh.

### TECHNICAL FIELD

The present invention relates to a fuel filter intended for use with internal combustion engines and more specifically Diesel engines.

### BACKGROUND ART

In many fuel supply circuits, and in particular for Diesel fuel, it is necessary to provide means for separating water from the fuel to prevent the water reaching the high pressure pump.

The prior art includes various filters that separate water from fuel.

A first type of filters comprise a depth type screen in a polymer material that induces coalescence of water and the descent of the water downstream of the screen relative to the direction of filtration. A second type of filter comprises a hydrophobic mesh, located in series with a normal filter screen in the filtration direction, which separates water from the fuel by coalescence.

In recent times there has been an increase in the use of fuels from renewable sources, also known as “biodiesel”. Fuels of this type normally contain a quantity of water which must be separated from the fuel, the water normally being in the form of very small droplets.

It has been established that only filters provided with a hydrophobic mesh guarantee adequate separation of the small water droplets generally dispersed in biodiesel fuel.

Simultaneously there has been increased use of so-called low environmental impact filters, commonly known as “green” filters, with the filter elements contained in a removable cartridge that can be removed from the filter body in order to enable replacement of the filter elements when they are clogged without the need to replace the entire filter.

In these filters the hydrophobic mesh for the separation of water is contained in the same removable cartridge that contains the filter screen and consequently the replacement of the filter screen also involves the removal of the hydrophobic mesh.

The hydrophobic mesh and the filter screen are frequently made from different materials which cannot be disposed of in the same procedure, resulting in the cartridges producing a relatively high environmental impact, contradicting the purpose of the filters to which they are associated.

Furthermore, when the filter screen is completely clogged, the hydrophobic mesh is normally still perfectly functional and consequently its replacement represents an unnecessary consumption of materials.

### DISCLOSURE OF INVENTION

The aim of the present invention is to obviate these limitations of known art, providing a rational and simple solution at a limited cost.

These aims are attained by the characteristics of the invention as described in independent claim 1. The dependent claims delineate preferred and/or particularly advantageous embodiments of the invention.

In particular, the invention provides a fuel filter, in particular for Diesel engines, comprising a closed casing with internal volume comprising at least a first chamber connected to an inlet for the fuel to be filtered and a second chamber connected to an outlet for the filtered fuel, with a hydrophobic mesh and a filter screen between the first and second chambers and with the filter screen removable from the filter independently of the hydrophobic mesh.

In this way a completely clogged filter screen can be replaced without removing the hydrophobic mesh, which remains associated to the filter and can be reused together with the replacement filter screen. The possibility of replacing only the filter screen also results in a reduction in materials for disposal or recycling, with a consequent reduction in costs and simplification of the required processes.

In a preferred embodiment of the invention the filter screen and the hydrophobic mesh are attached respectively to two distinct portions of the filter casing, the portions being reciprocally separable in order to permit the removal of the filter screen from the filter.

In this way, a single operation of opening the casing also achieves the separation and removal of the filter screen which remains associated to the respective portion of the casing while the hydrophobic mesh remains associated to the other portion of the casing.

A filter constructed in this way is also relatively simple from a constructional perspective.

The filter screen can be removably attached to the relative portion of the casing such that after demounting of the relative portion of casing the filter screen can be replaced without compromising the integrity of the filter casing.

The hydrophobic mesh can more simply be non-removably fitted to the relative portion of casing since the hydrophobic mesh generally does not need to be replaced during the useful life of the filter.

### BRIEF DESCRIPTION OF THE DRAWINGS

Further characteristics and advantages of the invention will better emerge from the detailed description made herein, provided by way of non-limiting example in the accompanying figures of the drawings.

FIG. 1 is a longitudinal cross-section, on a vertical plane, of a fuel filter, in particular for Diesel fuel, of the invention.

FIG. 2 is an enlarged detail of FIG. 1 showing a filter screen demounted from the filter.

### BEST MODE FOR CARRYING OUT THE INVENTION

The filter 1 comprises a closed casing 2 comprising a lower element 20, shaped substantially as a dish, and an upper cover 21 flat in shape and hermetically closing the lower element 20 by way of the interpositioning of a sealing element 22.

Afforded within the upper cover 21 is a duct 23 connected to the inside of the filter through an inlet 24 for the Diesel fuel to be filtered, and connected to the internal volume of the casing 2 through two distinct projecting inlet ducts 25.

The internal volume of the casing 2 is also connected to the outside through an outlet duct 26 for the filtered Diesel fuel, passing through the side wall of the lower element 20.

Located on the bottom of the lower element 20 are two hatches 27, both located coaxially below a respective inlet duct 25 and delimited by a cylindrical side wall extending a short distance inside the casing 2.

The casing 2 contains two cage elements 30, essentially cylindrical in shape, each coaxially positioned between an inlet duct 25 and the relative underlying hatch 27, extending substantially for the entire height of the lower element 20.

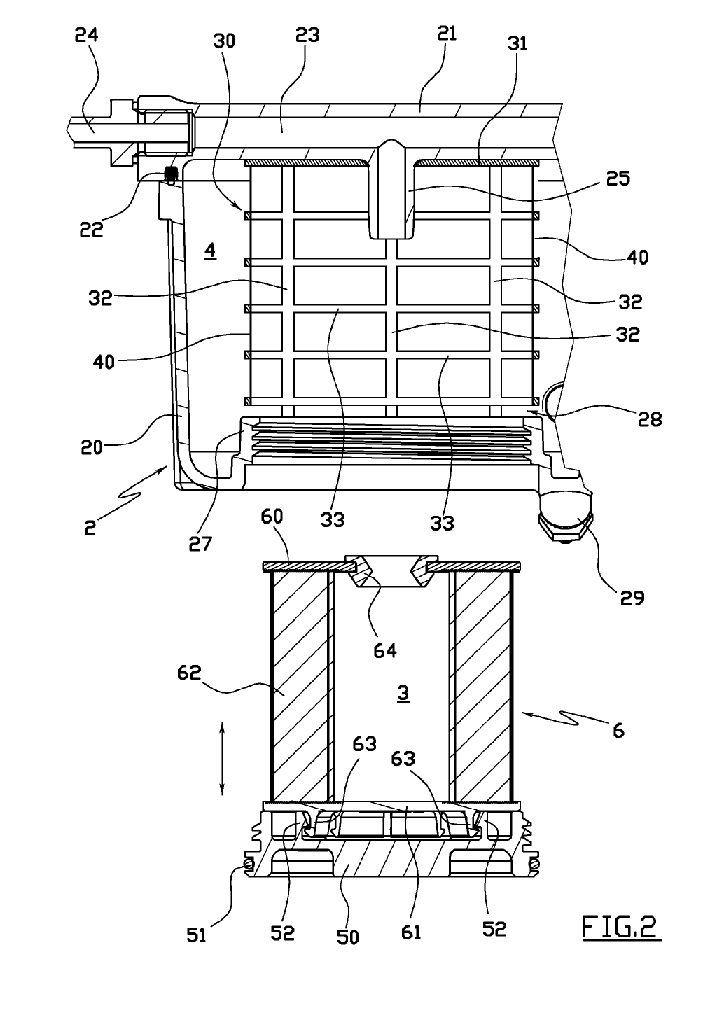

As illustrated in FIG. 2, each cage element 30 comprises an upper plate 31 with central perforation, inserted onto the respective inlet duct 25 and attached to the internal surface of the upper cover 21, for example using adhesive. Extending from the upper plate 31 are a plurality of vertical downwards-pointing rods 32 arranged around the perimeter of the circular edge of the upper plate 31 and bearing on the internal edge of the underlying hatch 27. The vertical rods 32 are reciprocally connected to transversal stiffening ribs 33, which together form a series of coaxial rings in sequence down the axial length of the cage element 30. The bottom of the cage element 30 remains open above the hatch 27.

Each cage element 30 is preferably made as a single part in plastic material.

The internal surface of each cage element 30 is covered with a hydrophobic mesh 40, which is fixed to the vertical rods 32 and to the transversal ribs 33, for example using adhesive, such as to form a cylindrical sheath that completely obstructs the openings in the cage element 30.

In more detail, the sheath of hydrophobic mesh 40 extends from the upper plate 31 almost arriving at the internal edge of the hatch 27 from which it remains separated by a small circular gap 28, which enables the water accumulated on the bottom of the lower element 20 to be drained.

Materials that might be used to form the hydrophobic mesh include: polytetrafluorethylene, or silicone, or equivalent substances.

It is also possible to use a mesh in polyamide treated by coating with silicone groups which make it hydrophobic.

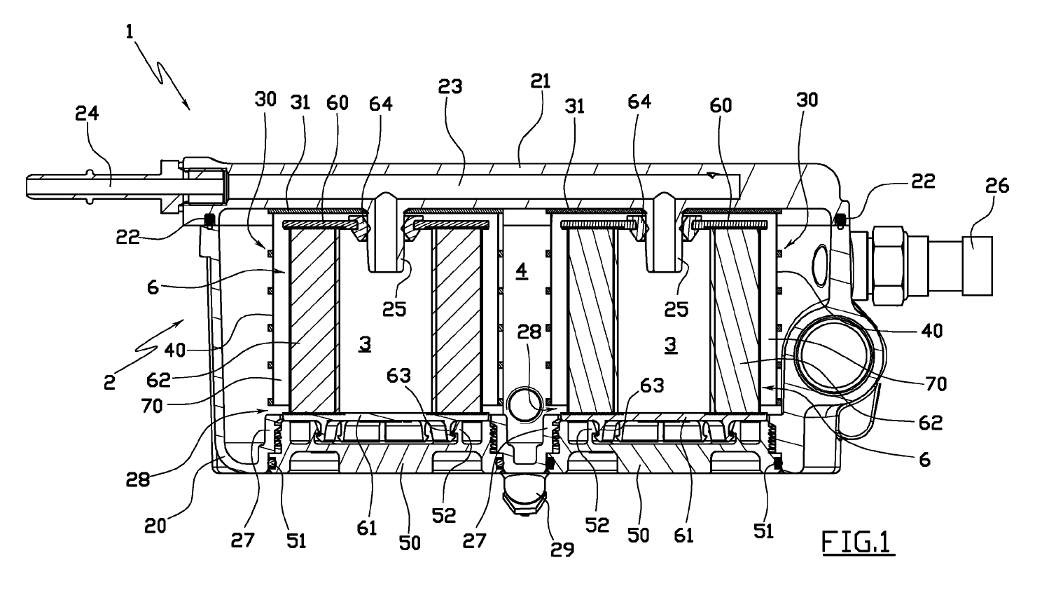

As illustrated in FIG. 1, each hatch 27 is hermetically sealed with a threaded disc-shaped screw ring 50, which screws into the recessed cylindrical wall, with the interpositioning of a sealing ring 51.

The screw ring 50 is attached to a filter cartridge 6 of essentially cylindrical shape and inserted coaxially into the cage element 30 positioned above the relative hatch 27, in such a way as to be completely surrounded by the hydrophobic mesh 40.

The filter cartridge 6 comprises an upper plate 60 and a lower plate 61, arranged such as to contain a filter screen 62 of cylindrical shape, for example a depth type screen, preferably of a coalescent type.

The lower plate 61 is removably attached to the screw ring 50, by means of a series of pawls 63 that engage by a snap fit action with respective pawls 52 formed on the internal face of the screw ring 50.

The upper plate 60 has a central perforation and is inserted onto the inlet duct 25 that extends into the relative cage element 30, with the interpositioning of a circular sealing element 64.

In this way each filter cartridge 6 delimits, inside the casing 2, a closed chamber 3 communicating directly with the inlet duct 24 for the Diesel fuel to be filtered and separated from the outlet duct 26 by the filter screen 62 and by the surrounding hydrophobic mesh 40.

The configuration described above results in the formation of a circular interspace 70 between the hydrophobic mesh 40 and the filter screen 62.

During functioning of the filter 1 described herein, the fuel to be filtered enters into each of the chambers 3, passing through the duct 23 and the relative inlet ducts 25. The Diesel fuel then passes through the filter screen 62, which in addition to retaining impurities also causes the coalescence of larger water droplets, and subsequently passes through the hydrophobic mesh 40 which separates the smaller water droplets, or droplets of dimensions not previously separated by the force of gravity or by the filter screen 62. The Diesel fuel filtered and separated from the water subsequently enters the remaining volume 4 inside the casing 2, from where it exits through the outlet duct 26.

The configuration of the hydrophobic mesh 40 and the filter screen 62 results in the water separated by the hydrophobic mesh 40 flowing vertically and collecting in the interspace 70, subsequently accumulating on the bottom of the lower element 20 passing through the circular gap 28.

The flow of water is also assisted by the vertical rods 32 of the cage element 30, facilitating the drainage of the water.

Periodically the water accumulated on the bottom of the lower element 20 is released through a drainage valve 29.

As illustrated in FIG. 2, the configuration of the hydrophobic mesh 40 and the filter screen 62 also permits the unscrewing of the screw ring 50 for the removal of the filter cartridge 6 from the filter 1 by extracting it axially from the bottom of the lower element 20 independently of the hydrophobic mesh 40 which instead remains fixed to the relative cage element 30.

After extraction, the filter cartridge 6 can be detached from the screw ring 50 for replacement as required by another similar filter cartridge 6 which is subsequently fitted in the filter 1 by inserting it axially into the cage element 30 and newly tightening the screw ring 50 onto the relative hatch 27.

In this way it is effectively possible to replace a completely clogged filter screen 62 without the need to also remove and replace the hydrophobic mesh 40, which, being located downstream of the filter screen 62 in the sense of flow of the Diesel fuel, is generally always clean.

Consequently, the hydrophobic mesh 40 can be used for the entire operating life of the filter 1, reducing the cost of production and system maintenance while the filter cartridge 6 can be quickly and easily replaced every time the filter screen 62 becomes clogged.

The possibility of replacing only the filter screen 62 also results in a reduction of waste materials for disposal or for recycling, with a resulting reduction in costs, simplification of disposal procedures, and reduced environmental impact of the filter cartridge 6.

A technical expert in the sector might introduce numerous modifications of a technical-applicational nature to the filter 1 as described herein above, without forsaking the ambit of protection of the invention as claimed herein below.

1. A fuel filter unit, in particular for Diesel engines, comprising a closed casing (2), an internal volume of which comprises at least a first chamber (3), communicating with an inlet (24) for fuel to be filtered, and a second chamber (4), connected to an outlet (26) of the fuel when filtered, a filter screen (62) and a hydrophobic mesh (40), being inserted between the first chamber (3) and the second chamber (4), wherein the filter screen (62) is located inside and surrounded by the hydrophobic mesh (40), and is demountable from the filter unit without removing the hydrophobic mesh, the filter screen being independently and removably attached to a fixed portion (27) of the closed casing.

2. The filter of claim 1, wherein the filter screen (62) is fixed to a portion (50) of the closed casing (2) which portion (50) is separable from a further portion (21) of the closed casing (2) to which the hydrophobic mesh (40) is attached, such as to enable removal of the filter screen (62) from the filter.

3. The filter of claim 2, wherein the filter screen (62) is removably attached to the relative portion (50) of the closed casing (2).

4. The filter of claim 2, wherein the hydrophobic mesh (40) is unremovably attached to the relative portion (21) of the closed casing (2).

5. The filter of claim 1, wherein the hydrophobic mesh (40) is associated to a cage element (30) contained inside the closed casing (2) and is destined to contain internally thereof the filter screen (62) such as to surround the filter screen (62) with the hydrophobic mesh (40).

6. The filter of claim 1, wherein the hydrophobic mesh (40) is located downstream of the filter screen (62), in terms of a flow of fuel passing from the first chamber (3) to the second chamber (4), and is separated from the filter screen (62) by an interspace (70).

7. The filter of claim 1, wherein the internal volume of the closed casing (2) comprises a plurality of first chambers (3), each of which is connected to an inlet (24) for the fuel to be filtered between each of the first chambers (3) and the second chamber (4), a filter screen (62) and a hydrophobic mesh (40) being interposed between each of the first chambers (3) and the second chamber (4), such that the filter screen (62) is removable from the filter independently of the hydrophobic mesh (40).
